(19) United States
(12) Patent Application Publication
(10) Pub. No.: US 2005/0166032 A1
(43) Pub. Date: Jul. 28, 2005

(54) Address generator for detecting and correcting read/write buffer overflow and underflow

(76) Inventors: Carsten Noeske, Sexau (DE); Ralf Herz, Freiburg (DE)

Correspondence Address: Patrick J. O'Shea;O'Shea, Getz & Kosakowski, P.C., Suite 912, 1500 Main Street, Springfield, MA, 01115, US

(21) Appl. No.: 10/855,887

(22) Filed: May 27, 2004

(30) Foreign Application Priority Data
May 27, 2003 (DE) 103 24 014.4

(51) Int. Cl. G06F 12/06

(52) U.S. Cl. 711/217

(57) ABSTRACT

An address generator comprises a read address register, a write address register, at least one counter for incrementing the registers after each output of a read address or write address, and an occupancy register. The address generator increments the occupancy register each time a write address is outputted, and decrements the occupancy register each time a read address is output.

### BACKGROUND OF THE INVENTION

The present invention relates to the field of address generators, an in particular to address generators for detecting and correcting read/write buffer overflow and underflow.

In systems that process data, such as signal data, address generators are frequently employed to generate write addresses and read addresses for access to a buffer memory. An address generator of this type typically comprises one or more address registers, the content of which may be outputted as a read address or write address to an address bus of the system, to which bus the buffer memory to be controlled is connected; as well as at least one counter or increment statement that functions to modify (i.e., to increment) the register after each output of a read address or write address, so as to advance the register to an address that follows the one just outputted—in an increasing or decreasing sequence. Usually, an address generator of this type also contains a modulo register in which the length of the buffer memory, more precisely, the number of its memory locations, is entered. Whenever the offset to the base address contained in the write register or read register is incremented by the value contained in the modulo register, the offset modulo of the buffer length is taken. The base address and offset may be stored in one register.

To determine the occupancy level of this buffer, from time to time the difference is calculated between the offset modulos of the buffer length contained in the write register and read register. This procedure functions as long as the data rates at which data are written to or read from the buffer do not differ excessively, and do not fluctuate excessively over time. Whenever these conditions are not met then between the two calculations of buffer occupancy, overflow may occur, and as a consequence. data in the buffer may be overwritten before they have been read. In the event of an underflow, it is the read register that overtakes the write register so that the data are read twice.

Therefore, there is a need for a technique for determining and controlling the occupancy of a buffer, and an address generator that enables buffer overflow or underflow to be reliably detected and their occurrence to be prevented.

### SUMMARY OF THE INVENTION

An occupancy register is incremented after each write operation to a buffer and decremented after each read operation to the buffer. An occupancy value contained within the occupancy registers may be read and, employed to trigger countermeasures against any overflow or underflow.

One approach to controlling the occupancy is to regulate the frequency of write accesses and/or read accesses to the buffer as a function of the occupancy determined. The simplest way to do this is to define a lower limit at which the read frequency is reduced or the write frequency is increased when values fall below it, or an upper limit at which the read frequency is increased or the write frequency is reduced when the limit is exceeded. Both limits may be identical so that two read frequencies or write frequencies above or below the limit are used.

The usual approach, however, is to use the deviation of the occupancy level from the target value and to raise or enable the read button or write button in proportion to the deviation.

Another mechanism of controlling occupancy is to use methods of accessing the buffer at different speeds. For example, as long as the occupancy of the buffer is low, it may be sufficient to read data each time from the buffer individually, whereas it may be necessary to change to block-by-block reading of the data when the limit has been exceeded in order to retrieve and process this data more quickly from the buffer.

The limit here must at least match the size of the block to be read since otherwise the action of reading the block itself may result in a memory underflow.

Conversely, it may be expedient to permit block-by-block reading to the buffer as long as its occupancy is low, and to reduce the data rate by inhibiting block-by-block writing if the occupancy exceeds a second limit. This second limit must not be greater than the difference between the size of the buffer and the size of a block to be read.

In a data-processing system, in order to control the data rate from a data source to a buffer memory and/or from a buffer memory to a data sink based on the detected occupancy level of the buffer, the address generator is configured and arranged to halt the data source when a first occupancy limit is exceeded and to restart the data source when values fall below a second limit (e.g., which may be identical with the first).

This type of occupancy control is suitable for a data-processing system in which a plurality of address generators and buffer memories receive data through a common bus from assigned sources. Specifically, since in this type of system a data source whose buffer memory has reached a critical occupancy has no claim to bandwidth on the bus, its transmission capacity is available for those data sources whose assigned buffers have receptive capacity.

In another embodiment, the buffer memory is connected to a write bus to receive data from one source, and a read bus to output data to a sink, that have mutually independent clock signals, and the address generator is designed to control the clock rate of at least one of the busses in order to adjust its data rate to a given detected occupancy level.

Advantageously, since the content of the occupancy register is current at all times, memory overflow or underflow can be detected and counteracted in time.

These and other objects, features and advantages of the present invention will become more apparent in light of the following detailed description of preferred embodiments thereof, as illustrated in the accompanying drawings.

### BRIEF DESCRIPTION OF THE DRAWING

FIG. 1 is a block diagram illustration of an address generator;

FIG. 2 is a block diagram illustration of a data-processing system that uses the address generator of FIG. 1; and

FIG. 3 is a block diagram illustration of an alternative embodiment data-processing system.

### DETAILED DESCRIPTION OF THE INVENTION

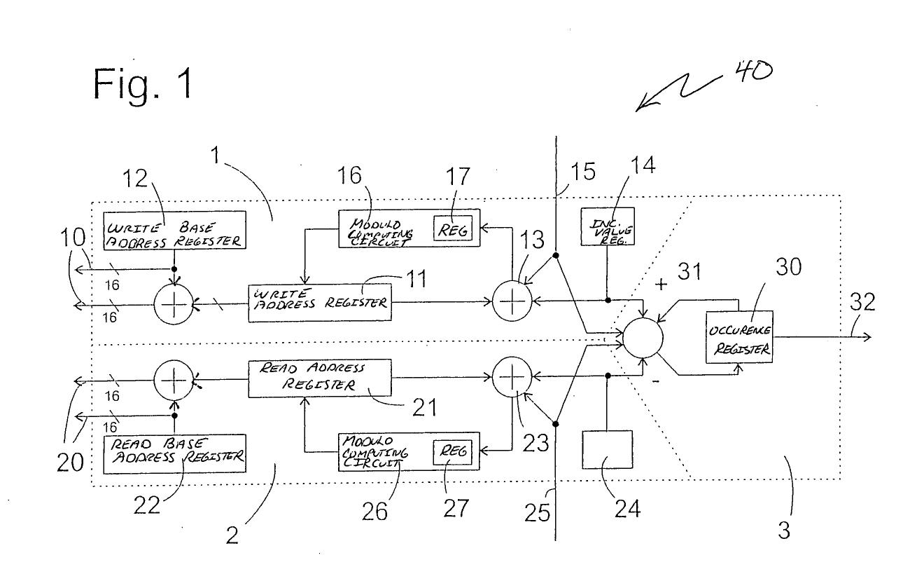

FIG. 1 is a block diagram illustration of an address generator 40. The address generator 100 includes a write address generator section 1, a read address generator section 2, and an occupancy section 3. In this embodiment, the structure of the two sections 1, 2 are preferably the same, and for this reason only one of the two is described here in detail—functionally analogous elements in the two sections have the same reference notations, except for the initial 1 or 2.

An address output 10 of the write address generator section comprises a plurality of bits (e.g., 32 bits), including one group of high-order bits (e.g., 16 bits) that correspond directly to the high-order bits (e.g., 16 bits) of a base address register 12, and low-order bits (e.g., 16 bits) that are generated by summing the low-order bits (e.g., 16 bits) of the base address register 12 and the content of a write address register 11. The identical output of write address register 11 is connected to the first input of adder 13, to whose second input the content of an increment value register 14 is applied. Increment value register 14 may be written to with the values ±1, ±2, ±4, depending on whether the buffer memory is read 1, 2, or 4 bytes at a time in an increasing or decreasing direction.

The adder 13 receives a trigger signal through a trigger input 15. The output of the adder 13 is connected to a modulo computing circuit 16 that comprises a register 17 in which the length of a buffer to be controlled by the address generator is stored. One output of the modulo computing circuit 16 is connected to a data input of the write address register 11. The contents of registers 14, 17 can be adjusted by external programming or by switches.

Whenever a data value is to be written to the buffer controlled by the address generator, a trigger pulse is applied to the trigger input 15. This trigger pulse causes the adder 13 to add the values outputted by the registers 11, 14, and supply them to the modulo computing circuit 16. The content of the increment value register 14 corresponds to the number of memory locations of the buffer memory that can be written to simultaneously during a single write (or read) access to the buffer memory (i.e., the width of the data bus to which the buffer memory is connected, in bytes).

When the content of the increment value register 14 is positive, in other words, the buffer memory is being written to and read in the direction of increasing addresses, the modulo computing circuit 16 compares the result of the addition with the content of the length register 17. If the result is smaller, it outputs it to the write address register, whose content is overwritten by the new value.

The sum of the new content of the write address register 11 and of the content of the base address register 12 then appears at address output 10 so that a byte identified by this address from the buffer memory (and possibly, depending on the width of the data bus, one or three of the following) can be written.

If the modulo computing circuit 16 determines that the result outputted by the adder 13 is greater than or equal to length of the buffer entered in the buffer length register 17, the circuit subtracts the content of the register from the result of the adder 13 and passes on the difference thus obtained to the write address register 11.

If the content of the increment value register 14 is negative, the modulo computing circuit compares the result with zero, and, if the result is smaller, the circuit adds on the content of the length register 17. Using this result, it overwrites the write address register 11.

If the write address has reached the end of the buffer, it is returned in this manner by the modulo computing circuit 16 to the opposite end of the buffer, and the buffer is once again written to completely from one end to the other.

Analogously, the read address generator section 2 is prompted by pulses applied by its trigger input 25 to output successive read addresses to the buffer.

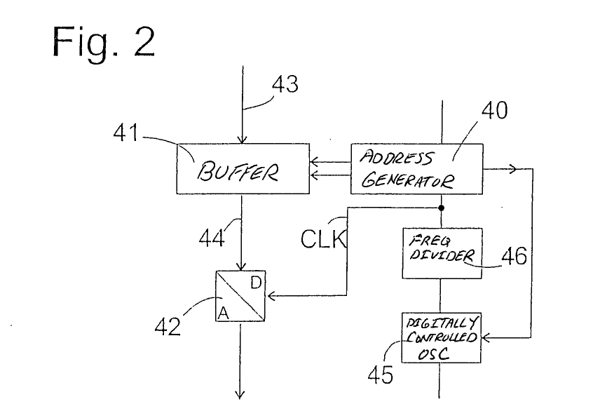

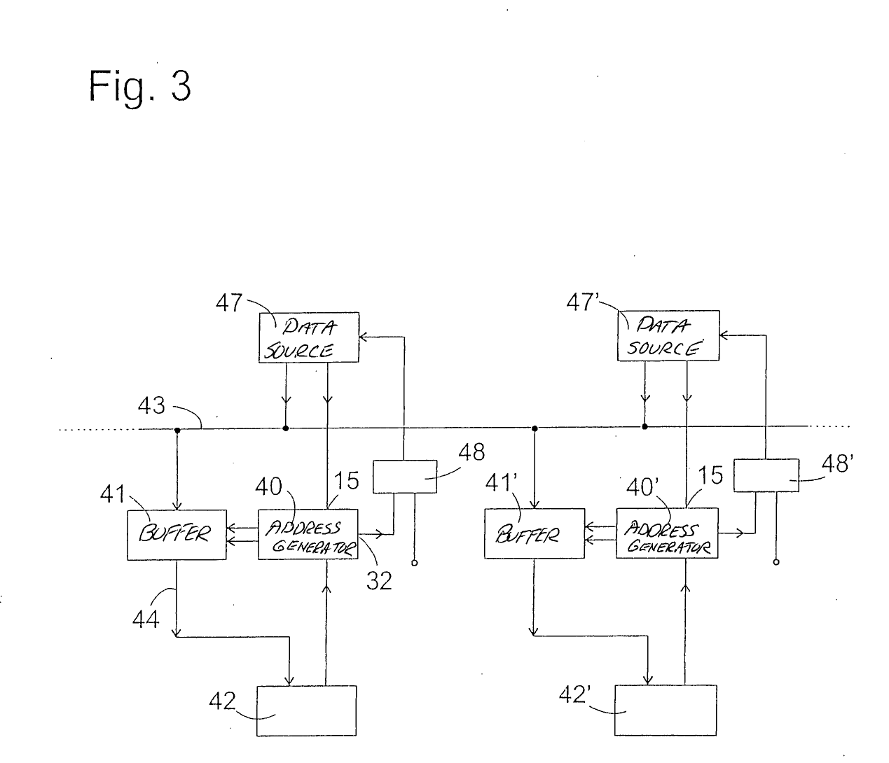

The occupancy measurement section 3 comprises an occupancy register 30 and an adder 31 that is connected to both trigger inputs 15, 25, to add the content of increment value register 14 to the occupancy register 30 when a trigger signal is received at input 15, or to subtract the content of increment value register 24 from this value when a trigger signal is received at the trigger input 25. The value in the occupancy register 30 when this register is initialized to zero—for example, upon startup of the buffer memory—corresponds exactly to the number of written but not yet read memory locations in the buffer memory. This count value is continuously applied at an output 32 of the address generator and may be accessed to control the data traffic in a data-processing system, as will be illustrated below based on the embodiments of FIGS. 2 and 3.

In the block diagram of FIG. 2, the address generator 100 from FIG. 1 is identified as 40, and buffer 41 supplies the generator with write and read addresses. A D/A converter 42, as an example of a data sink, is connected following buffer 41. A data source that supplies the digital data converted by the D/A converter 42 to the buffer 41 through a write bus 43 is not shown in the FIG. 2. A digitally controlled oscillator 45 and a frequency divider 46 connected following this oscillator supply a clock signal CLK to the address generator 40 and the D/A converter 42, which signal determines the frequency at which data from the buffer 41 are read and converted. The oscillator 45 receives on line 50 as the frequency control signal the occupancy level for the buffer of the address generator 40. Within a predetermined synchronizing interval, the oscillator 45 sets its output frequency increasingly higher as the occupancy value supplied to it becomes higher. The synchronizing interval is determined so that at its upper limit the read frequency is higher than the maximum anticipated write frequency on the write bus 43, and at its lower limit is lower than the minimum anticipated write frequency. As a result, at a high count the data are read more quickly from the buffer 41 than they are supplied through the write bus 43, and at a low occupancy level the data are read more slowly—with the result that in both cases the occupancy level tends toward an average value.

If the read frequency is a “constant” function of the count, this ensures that an essentially constant data rate is obtained on the read bus 44. Another conceivable approach, however, is to provide only two or three possible discrete frequency values for the oscillator 45, from which the oscillator 45 sets the highest value whenever the count exceeds an upper limit, and sets the lowest value whenever the count falls below a lower limit.

The data-processing system illustrated in FIG. 3 comprises a plurality of data sources 47, 47′, . . . which transmit data through a common write bus 43 to a buffer memory each 41, 41′ assigned to them. Each data source 47, 47′, . . . is connected to trigger input 15 of the address generator 40, 40′ assigned to the source, so as to prompt the generator to provide a write address whenever the data source 47, 47′, . . . intends to write data through bus 43 to their associated buffer 41, 41′.

The occupancy output 32 of each address generator 40,40′, . . . is connected to an input of a comparator 48, 48′, . . . at the input of which a reference value is applied. When the count, for example, of the address generator 40 exceeds the reference value, the comparator 48 supplies an inhibiting signal to the data source 47 that prevents this source from sending additional data on the write bus 43. The data sink 42 connected to the buffer 41 thus obtains time to finish processing the data accumulated in the buffer 41. Since the data source 47 is inhibited during this time, it does not compete with other data sources 47′, . . . for transmission capacity to the bus 43 with the result that the transmission capacity of these latter sources is improved.

FIG. 3 is a block diagram illustration of an alternative embodiment data-processing system. In this embodiment the mode of operation of the address generator 40 differs from the one presented above. In this additional embodiment, each data source 47, 47′, . . . supports at least two different transmission modes: a first mode in which the data values are all transmitted individually, and a second mode in which packets created from a predetermined plurality of data values are transmitted. Whenever the transmission capacity available on the write bus 43 allows, the individual transmission mode will generally be used since this mode enables shorter delay times for transmission of the data to the sink than does the packet mode. Whenever the transmission capacity of the bus 43 becomes tight due to the many data sources accessing it, the result is that the counts in the assigned address generators 40, 40′ decrease. The comparators 48, 48′, . . . switch the data sources 47, 47′ from individual transmission to packet transmission whenever values fall below a critically low count.

Additionally in the case of a data-processing system in which only a single data source is connected to a buffer through one write bus, it may be useful to provide different modes of transmission. In a system of this type, for example a comparator analogous to the comparator 48 of FIG. 3 may function to generate a control signal that prohibits the data source from using the packet mode when a limit is exceeded, while enabling it to choose whether or not to use the packet mode when values fall below the limit. In such a system, the data source may decide about the use of the packet mode by taking into account, for example, a data volume to be transmitted to the buffer 41 that has been pre-buffered in the source. The data source may thus use the packet mode to boost the occupancy level of the buffer 41 whenever this source temporarily experiences a high data rate. This is especially advantageous in cases when this occupancy level is used, as described in the example of FIG. 2, to control the rate at which the data are transferred to the sink.

Although the above discussion involved a case in which the occupancy register 30 is only incremented for each write operation to the buffer 41, decrementing is of course also possible. Then, however, the occupancy register 30 must be incremented for each read operation from the buffer 41.

Although the present invention has been shown and described with respect to several preferred embodiments thereof, various changes, omissions and additions to the form and detail thereof, may be made therein, without departing from the spirit and scope of the invention.

1. Method of determining the occupancy level of a buffer, comprising the steps:
a) initializing an occupancy register;
b) incrementing or decrementing the occupancy register for each write operation to the buffer:
c) decrementing or incrementing the occupancy register for each read operation from the buffer; and
d) reading the occupancy level from the occupancy register.

2. The method of claim 1, comprising controlling and write and read accesses to the buffer based on the occupancy level determined.

3. The method of claim 2, wherein when values fall below a lower limit the read frequency is decreased or the write frequency is increased, or, when an upper limit is exceeded, the read frequency is increased or the write frequency is decreased.

4. The method of claim 2, wherein during block-by-block reading from the buffer an enable action is provided when a first limit is exceeded, and an inhibit action is provided when values fall below a second limit.

5. The method of claim 4, wherein the limits at least match the size of the block to be read.

6. The method of claim 2, wherein during block-by-block writing to the buffer an inhibit action is provided when a first limit is exceeded, and an enable action is provided when values fall below a second limit.

7. The method of claim 6, wherein the limits correspond at most to the difference between the size of the buffer and the size of a block to be read.

8. An address generator, comprising:
a read address register, a write address register, and at least one counter for incrementing or decrementing the registers after the output of a read address or write address, characterized in that the address generator comprises an occupancy register and means for incrementing or decrementing the occupancy register each time a write address is outputted, and for decrementing the occupancy register each time a read address is outputted.

9. A data-processing system, comprising:
an address generator that includes a read address register, a write address register, and at least one counter for incrementing or decrementing the registers after the output of a read address or write address, wherein the address generator comprises an occupancy register and means for incrementing or decrementing the occupancy register each time a write address is outputted, and for decrementing the occupancy register each time a read address is outputted;
a buffer memory; and
a data source for writing data to the buffer memory at write addresses identified by the address generator, and a data sink for reading data from the buffer memory at read addresses identified by the address generator, wherein the address generator is designed to control the data rate from the source to the buffer memory and/or from the buffer memory to the sink based on the determined occupancy level of the buffer memory.

10. The data-processing system of claim 9, wherein the address generator is configured and arranged to halt the data source when a first occupancy limit is exceeded, and to start the data source when values fall below a second limit.

11. The data-processing system of claim 10, wherein the system comprises a plurality of address generators and buffer memories that receive data from the assigned sources through a common bus.

12. The data-processing system of claim 11, wherein the system comprises a write bus through which the buffer memory receives data, and a read bus to which the buffer memory outputs data, and that the address generator is designed to control the transmission rate of at least one of the busses.

13. The data-processing system of claim 12, wherein the address generator is designed to enable block-by-block reading from the buffer memory when a first limit is exceeded, and to inhibit it when values fall below a second limit.

14. The data-processing system of claim 9, wherein the address generator is designed to enable block-by-block writing to the buffer memory when a first limit is exceeded, and to inhibit it when values fall below a second limit.
